(19) United States
(12) Patent Application Publication
(10) Pub. No.: US 2011/0195946 A1
(43) Pub. Date: Aug. 11, 2011

(54) HIGH SOLID DISPERSIONS COMPRISING BIOCIDES

(76) Inventors: Martyn Charles Barker, Beerse (BE); Dimitri Dennis Paul Verheyen, Beerse (BE)

(21) Appl. No.: 13/123,382

(22) PCT Filed: Oct. 6, 2009
(86) PCT No.: PCT/EP2009/062957

§ 371 Date: Apr. 8, 2011

(30) Foreign Application Priority Data
Oct. 8, 2008 (EP) 08166097.9

(51) Int. Cl. A01N 55/02; A01N 43/36; A01N 41/02; A01P 1/00

(52) U.S. Cl. 514/188; 514/427; 514/600

(57) ABSTRACT

The present invention relates to dispersions comprising a biocide selected from tralopyril, zinc pyrithione or tolylfluanid, or a combination of thereof, a polymeric surfactant, an anti-settling agent and one or more carrier liquids. These dispersions have a solids level up to 80% by weight and provide a zero-dust delivery system when used in antifouling coating formulations.

The present invention relates to dispersions comprising a biocide selected from tralopyril, zinc pyrithione or tolylfluanid, or a combination of thereof, a polymeric surfactant, an anti-settling agent and one or more carrier liquids. These dispersions have a solids level up to 80% by weight and provide a zero-dust delivery system when used in antifouling coating formulations.

Biocides such as tralopyril and zinc pyrithione are well known compounds useful in a wide variety of applications as an antibacterial, antifungal or antifouling agent. These biocides are usually sold as dry powder for use in paints and coatings. A disadvantage of such dry powder is that it generates dust during handling thereby necessitating special handling equipment as these biocides can cause irritation to a worker's finger or hands upon contact. Also workers have to put on suitable protective equipments such as dust preventive masks, protective glasses, protective gloves, protective clothes and the like during handling of these compounds. In addition, a local exhaust system is typically installed so as not to contaminate the work environment with the powder dust generated when handling these biocides.

Tralopyril has a LD₅₀ of 28.7 mg/kg for acute oral mammalian toxicity by oral digestion and zinc pyrithione has a LC₅₀ (4 h) of 1.03 mg/L for acute inhalation toxicity. Given these problems when handling biocides in dry powder form the creation of a zero-dust delivery system was seen as beneficial.

A zero-dust delivery system for use by paint or coating companies is preferably a liquid delivery system that releases no dust in the air, allows for easy handling, is highly concentrated and is also storage stable and easily pourable.

Such a liquid delivery system for the biocides tralopyril, zinc pyrithione and tolylfluanid has been found to comprise of the following:
a biocide selected from tralopyril, zinc pyrithione, or tolylfluanid, or a combination thereof, in an amount up to 80% by weight based on the total weight of the dispersion,
a polymeric surfactant;
an anti-settling agent;
a carrier liquid; and
optional formulation agents such as fillers, binders, resins, etc.

Tralopyril is disclosed in EP-0,312,723-A for controlling mollusks and its use in antifouling compositions is disclosed in EP-0,746,979. Said compound is also known under its scientific name as 4-bromo-2-(4-chlorophenyl)-5-(trifluoromethyl)-1H-pyrrole-3-carbonitrile and is represented by the formula:

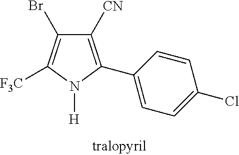

Zinc pyrithione, also known as zinc omadine, is a coordination complex first reported in the 1930s. It features two pyridine-derived chelating ligands bound to zinc via oxygen and sulfur atoms. Its IUPAC name is bis(2-pyridylthio)zinc 1,1′ dioxide as is represented by the following formula:

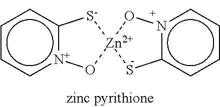

Zinc pyrithione is best known for its use in treating dandruff and seborrheic dermatitis. Due to its low solubility in water it is suitable for use in outdoor paints and other products that provide protection against mildew and algae.

Tolylfluanid has a broad spectrum antimicrobial activity and is the generic name of the compound 1,1-dichloro-N-[(dimethylamino)sulfonyl]-1-fluoro-N-phenyl-methanesulfenamide, which compound is represented by the formula

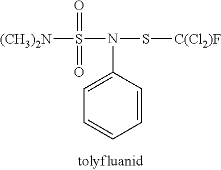

For the purposes of this invention, the term “dispersion” refers to a system of fine particles that are evenly distributed in a liquid medium. The term “surfactant” refers to a product for reducing interfacial tension of two boundary surfaces, thereby increasing the emulsifying, spreading, dispersability or wetting properties of liquids or solids. The term “anti-settling agents” refers to products used to keep fine particles in suspension.

Polymeric surfactants that are suitable for use in the dispersions of the present invention are:
alkyd polyethylene glycols such as Atlox 4914 available from Croda; and
ABA polyhydroxyester-PEG-polyhydroxyester copolymers such as Hypermer B246 and Zephrym PD2206 available from Croda.

Particularly preferred are polymeric surfactants which have the necessary approval for pesticide use. In the USA, for example, this would require EPA approval for pesticide use under lists such as “Inert ingredients permitted in pesticide products: non-food inert ingredients” or EPA lists such as 40 CFR §180.910 “Inert ingredients used pre- and post-harvest; exemptions from the requirement of a tolerance”, 40 CFR §180.950 “Tolerance exemptions for minimal risk active and inert ingredients” or 40 CFR §180.960 “Polymers; exemptions from the requirement of a tolerance”.

Anti-settling agent that are suitable for use in the high solid dispersions of the present invention are fumed silica, calcium carbonate, modified castor oils, modified cellulose polymers, bentonite, hectorite or chemically modified derivatives. Optionally these anti-settling agents are used in combination with propylene carbonate as an activator.

Specific examples of these anti-settling agents are:
Bentone 38 is quaternium 18-hectorite (CAS 12001-31-9) and is commercially available from Elementis Specialties;
Bentone gel MIO Visa mixture of quaternium 18-hectorite (CAS 12001-31-9) and propylene carbonate in a mineral oil and is commercially available from Elementis Specialties;
Tixogel MIO-1584 is a mixture of quaternium 90-bentonite (CAS 226226-22-8) with propylene carbonate and a mineral oil and is commercially available from Süd-Chemie;
fumed silica (also known as pyrogenic silica); and
ultrafine calcium carbonate.

Alternatively, depending on the carrier liquid employed, other chemical types of anti-settling agent may be employed such as:
Ircothix 2000 is a carboxylate gel-based rheological agent available from Lubrizol Advanced Materials;
Crayvallac CVP a hydrogenated castor oil-based rheological agent; and
Rhodapol 23 a xanthan gum.

Carrier liquids that are suitable for use in the high solid dispersions of the present invention are isoparaffinic solvents, dearomatized aliphatic hydrocarbon fluids, heavy aromatic hydrocarbons, paraffin oils, toluene, ethylbenzene, trimethylbenzene, xylene, diisononyl phthalate and propylene oxide polyether polyols, or mixtures thereof. A particular group of carrier liquids are isoparaffinic solvents, dearomatized hydrocarbon fluids, heavy aromatic hydrocarbons, paraffin oils, xylene, diisononyl phthalate, and propylene oxide polyether polyols.

Specific examples of such carrier liquids are:
isoparaffinic solvents available from ExxonMobil as Isopar C, E, G, H, K, L, M and V;
dearomatized aliphatic hydrocarbon fluids available from ExxonMobil under the tradename Exxsol such as Exxsol Pentane 80, Exxsol penthylpentane naphta, Exxsol hexane, Exxsol heptane, Exxsol isopentane S, Exxsol isohexane, Exxsol cyclopentane S, Exxsol D30, Exxsol D40, Exxsol D50, Exxsol D60, Exxsol D80, Exxsol D95, and the like;
heavy aromatic hydrocarbons available from ExxonMobil under the tradename Solvesso such as Solvesso 100, Solvesso 150, naphthalene depleted Solvesso 150, Solvesso 200, naphthalene depleted Solvesso 200, Solvesso 200 S, and the like;
paraffin oils available from Petrochem Carless under the tradename Brisopar;
alkylbenzenes such as toluene, ethylbenzene, trimethylbenzene and xylene;
DINP (diisononyl phthalate); and
propylene oxide polyether polyols available as Voranol products from Dow Chemical, Lupranol from Elastogran or Jeffol polyols from Huntsman.

The term “carrier liquid” is to be understood both in the singular as the plural as mixtures of more than one carrier liquid are also intended to be covered by the term “carrier liquid”.

Optional formulations agents are e.g. inert fillers which are used in the high solid dispersions of the present invention having a lower amount of biocide. Such inert fillers are e.g. talc. Other optional formulation agents are e.g. resins such as Indonesian gum rosin, binders such as Neocryl B-725; a solid acrylic (BMA/MMA) copolymer available from DSM Neoresins.

Accordingly the invention provides a dispersion comprising
a) a biocide selected from tralopyril, zinc pyrithione, or tolylfluanid, or combinations thereof in an amount up to 80% by weight;
b) a polymeric surfactant selected from alkyd polyethylene glycols and ABA polyhydroxyester-PEG-polyhydroxyester copolymers, in an amount ranging from 0.1 to 30% by weight;
c) an anti-settling agent selected from fumed silica, calcium carbonate, modified castor oils, modified cellulose polymers, bentonite, hectorite, or chemically modified derivatives thereof, or mixtures thereof, and optionally propylene carbonate, in an amount ranging from 0.01 to 10% by weight;
d) a carrier liquid selected from isoparaffinic solvents, dearomatized aliphatic hydrocarbon fluids, heavy aromatic hydrocarbons, paraffin oils, toluene, ethylbenzene, trimethylbenzene, xylene, diisononyl phthalate and propylene oxide polyether polyols, or mixtures thereof; and
e) optionally other formulation agents.

The dispersions of the present invention have a high solids level up to 80% by weight of the total dispersion. In an embodiment the dispersions have a solids level ranging from 20 to 80% by weight or ranging from 30 to 60% by weight.

The high solid dispersions of the present invention have a viscosity of a level that allows them to be used directly in the preparation of coatings or paints without the need to dilute said high solid dispersions. Preferably the viscosity of the high solid dispersions is less than 10000 mPa·s, more preferably less than 5000 mPa·s, when measured.

For simple Newtonian fluids the viscosity (η) is given from the ratio between applied shear stress (τ) and the measured shear rate (γ) i.e.

η=τ/γ

The systems described here, however, frequently display more complex shear thinning, pseudoplastic rheology where the viscosity is dependent on the applied shear rate. The values quoted above were determined by measuring the viscosity at a range of shear rates and extrapolating to obtain the flow viscosity at the limiting Newtonian high-shear plateau by fitting the viscosity data to the Casson equation as has been described in “Dispersion of Powders in Liquids. Third Edition. Parfitt 1981 Applied Science Publishers ISBN 0-85334-990-8”.

τ^{0.5}=τ₀^{0.5}+A.(γ^{0.5})

where τ₀ is the so-called yield value which is the force which needs to be applied before the sample begins to move and A is a constant dependent upon the system being measured.

The amount of surfactant ranges from 0.1 to 30% by weight or from 0.5 to 10% by weight.

The amount of anti-settling agent ranges from 0.01 to 10% by weight, or from 0.1 to 5% by weight.

### TYPICAL FORMULATION EXAMPLES

### Formulation 1

Formulation 1 was prepared by melting the polymeric surfactant Hypermer B246 at a temperature of approximately 60° C. and by mixing it with the carrier liquid Exxsol D80 until a clear homogenous solution was obtained. Then the tolylfluanid powder and the anti-settling agent Bentone gel MIO-V were added successively whereby each time the dispersion was homogenised using disc impellor mixing before adding the following component.

| Component: | Product: | Amount (% w/w) |
|---|---|---|
| Biocide | tolylfluanid | 45.00 |
| Polymeric surfactant | Hypermer B246 | 4.50 |
| Anti-settling agent | Bentone gel MIO-V | 7.50 |
| Carrier liquid | Exxsol D80 | 43.00 |

### Formulation 2

Formulation 2 was prepared by melting the polymeric surfactant Hypermer B246 at a temperature of approximately 60° C. and by mixing it with the carrier liquid Exxsol D80 under constant stirring until a clear homogenous solution was obtained. Then tralopyril powder and the anti-settling agent Bentone 38 were added successively whereby each time the dispersion was homogenised using disc impellor mixing before adding the following component. To activate the Bentone 38, propylene carbonate was added while high shearing the formulation using a rotor-stator mixer

| Component: | Product: | Amount (% w/w) |
|---|---|---|
| Biocide | tralopyril | 60.00 |
| Polymeric surfactant | Hypermer B246 | 6.30 |
| Anti-settling agent | Bentone 38 | 1.00 |
| Carrier liquid | Exxsol D80 | 32.37 |
| Activator | propylene carbonate | 0.33 |

### Formulation 3

Formulation 3 was prepared by liquidizing the polymeric surfactant Atlox 4914 at a temperature of approximately 60° C. and by mixing it with the carrier liquid Exxsol D60 under constant stirring until a clear homogenous solution was obtained. Then the zinc pyrithione powder, the tralopyril powder and the anti-settling agent Bentone gel MIO V were added successively whereby each time the dispersion was homogenised using disc impellor mixing before adding the following component.

| Component: | Product: | Amount (% w/w) |
|---|---|---|
| Biocide 1 | tralopyril | 26.04 |
| Biocide 2 | zinc pyrithione | 26.04 |
| Polymeric surfactant | Atlox 4914 | 4.17 |
| Anti-settling agent | Bentone gel MIO V | 8.33 |
| Carrier liquid | Exxsol D60 | 35.42 |

### Formulation 4

Formulation 4 was prepared by mixing the polymeric surfactant Zephrym PD 2206 with the carrier liquid composed of a mixture of xylene and Isopar K under constant stirring until a clear homogenous solution is obtained. Then tralopyril powder and the anti-settling agent Bentone 38 were added successively whereby each time the dispersion is homogenised using disc impellor mixing before adding the following component. To activate the Bentone 38, propylene carbonate was added while high shearing the formulation using a rotor-stator mixer.

| Component: | Product: | Amount (% w/w) |
|---|---|---|
| Biocide | tralopyril | 59.00 |
| Polymeric surfactant | Zephrym PD2206 | 4.00 |
| Anti-settling agent | Bentone 38 | 1.20 |
| Carrier liquid | Isopar K | 28.40 |
| Carrier liquid | xylene | 7.00 |
| Activator | propylene carbonate | 0.40 |

### Formulation 5

Formulation 5 was prepared by melting the polymeric surfactant Hypermer B246 at a temperature of approximately 60° C. and mixing it with the carrier liquid Isopar L under constant stirring until a clear homogenous solution is obtained. Then the zinc pyrithione powder and the anti-settling agent Bentone 38 were added successively whereby each time the dispersion was homogenised using disc impellor mixing before adding the following component. In order to activate the Bentone 38, propylene carbonate was added while shearing the formulation using a rotor-stator mixer. The talc was added to this mixture and the total system remixed with a disc impellor until a homogeneous dispersion was achieved.

| Component: | Product: | Amount (% w/w) |
|---|---|---|
| Biocide | zinc pyrithione | 30.00 |
| Polymeric surfactant | Hypermer B246 | 5.00 |
| Anti-settling agent | Bentone 38 | 1.50 |
| Carrier liquid | Isopar L | 31.00 |
| Activator | propylene carbonate | 0.50 |
| Additive | talc | 32.00 |

### Formulation 6

Formulation 6 was prepared by liquidizing the polymeric surfactant Atlox 4914 at a temperature of approximately 60° C. and mixing it with the carrier liquid Solvesso 150 n.d. under constant stirring until a clear homogenous solution is obtained. Then tralopyril powder and the anti-settling agent Bentone gel MIO V were added successively whereby each time the dispersion is homogenised using disc impellor mixing before adding the following component. Finally the Indonesian gum rosin was dissolved into the dispersion with constant mixing.

| Component: | Product: | Amount (% w/w) |
|---|---|---|
| Biocide | tralopyril | 51.00 |
| Polymeric surfactant | Atlox 4914 | 7.00 |
| Anti-settling agent | Bentone gel MIO V | 2.00 |
| Carrier liquid | Solvesso 150 n.d. | 20.00 |
| Other | Indonesian gum Rosin | 20.00 |

Comparative formulation 1: no polymeric surfactant

Comparative formulation 1 was prepared by adding the tralopyril powder to the carrier liquid and homogenising using a disc impellor mixer.

| Component: | Product | Amount (% w/w) |
|---|---|---|
| Biocide | tralopyril | 52.00 |
| Carrier liquid | Exxsol D80 | 48.00 |

Comparative formulation 1 was a semi-liquid paste, stirrable, but not able to be poured properly. It was not possible to measure this formulation using an AR2000 rheometer from TAinstruments. Because the sample was not liquid-like enough, the instrument was not able to bring the spindle down to the required gap.

Comparative formulation 2: no anti-settling agent

Comparative formulation 2 was prepared by melting the polymeric surfactant Hypermer B246 at a temperature of approximately 60° C. and by mixing it with the carrier liquid Exxsol D80 under constant stirring until a clear homogenous solution was obtained. Then tralopyril powder was added and the dispersion homogenised using disc impellor mixing.

| Component: | Product: | Amount (% w/w) |
|---|---|---|
| Biocide | tralopyril | 60.00 |
| Polymeric surfactant | Hypermer B246 | 5.00 |
| Carrier liquid | Exxsol D80 | 33.67 |

Comparative formulation 2 was very liquid-like, pourable and could be handled using an AR2000 rheometer from TAinstruments.

Comparative formulation 3: no polymeric surfactant

Comparative formulation 3 was prepared by adding the zinc pyrithione powder to the carrier liquid and homogenising using a disc impellor mixer.

| Component: | Product | Amount (% w/w) |
|---|---|---|
| Biocide | zinc pyrithione | 25.00 |
| Carrier liquid | Isopar M | 75.00 |

Comparative formulation 3 was a thixotropic liquid which could be handled by an AR2000 rheometer with a 4 cm 2° cone spindle from TA instruments. The formulation displayed a high casson yield value without containing any anti-settling agent.

Comparative formulation 4: no anti-settling agent

Comparative formulation 4 is prepared by melting the polymeric surfactant Hypermer B246 at a temperature of approximately 60° C. and by mixing it with the carrier liquid Isopar M under constant stirring until a clear homogenous solution was obtained. Then zinc pyrithione powder is added and the dispersion homogenised using disc impellor mixing.

| Component: | Product: | Amount (% w/w) |
|---|---|---|
| Biocide | zinc pyrithione | 25.00 |
| Polymeric surfactant | Hypermer B246 | 2.50 |
| Carrier liquid | Isopar M | 72.25 |

Comparative formulation 4 could not be handled by an AR2000 rheometer with a 4 cm 2° cone spindle because the sample was so liquid that the cone could not be filled. Using the double concentric cylinder configuration on the AR2000 it was possible to measure this sample. Comparative formulation 4 has almost a Newtonian flow behaviour.

Comparative formulation 5: no polymeric surfactant

Comparative formulation 5 was prepared by adding the zinc pyrithione powder to the carrier liquid and homogenising using a spatula.

| Component: | Product | Amount (% w/w) |
|---|---|---|
| Biocide | zinc pyrithione | 50.00 |
| Carrier liquid | Isopar M | 50.00 |

Comparative formulation 5 was a pasty solid which could not be mixed using a disc impellor mixer.

Comparative formulation 6: no anti-settling agent

Comparative formulation 6 is prepared by melting the polymeric surfactant Hypermer B246 at a temperature of approximately 60° C. and by mixing it with the carrier liquid Isopar M under constant stirring until a clear homogenous solution was obtained. Then zinc pyrithione powder is added and the dispersion homogenised using disc impellor mixing.

| Component: | Product: | Amount (% w/w) |
|---|---|---|
| Biocide | zinc pyrithione | 60.00 |
| Polymeric surfactant | Hypermer B246 | 6.00 |
| Carrier liquid | Isopar M | 34.00 |

Comparative formulation 6 is a very liquid-like dispersion which could be handled by an AR2000 rheometer

### Viscosity

A TA Instruments AR2000 rheometer was employed for the rheological measurements normally using a 4 cm 2° cone and plate configuration at 25° C. (comparative example 4 was measured using a double concentric cylinder instead of a cone and plate configuration because of its low viscosity). The Casson flow viscosities and Casson yield values quoted below were determined by fitting the viscosity data to the Casson equation as has been described in “Dispersion of Powders in Liquids. Third Edition. Parfitt 1981 Applied Science Publishers ISBN 0-85334-990-8”.

| | Casson Yield Value (τ₀) | Casson Flow |
|---|---|---|
| Formulation | Pa | Viscosity (y) Pa · s |
| 1 | 2.888 | 0.06240 |
| 2 | 10.160 | 0.7900 |
| 3 | 25.72 | 0.2130 |
| 4 | 3.332 | 0.1261 |
| 5 | 16.170 | 0.08118 |
| 6 | 9.476 | 2.432 |
| Comparative example 1 | Not measurable | not measurable |
| Comparative example 2 | 3.094E−6 | 0.08204 |
| Comparative example 3 | 2.868 | 8.900E−3 |
| Comparative example 4 | 1.852E−5 | 4.347E−3 |
| Comparative example 5 | not measurable | not measurable |
| Comparative example 6 | 2.679E−6 | 0.1401 |

### Storage Stability

The samples were stored in sealed glass vials at 40° C. in a constant temperature cabinet and the degree of settling assessed on a regular basis by measuring the formation of a clear supernatant layer at the top of the sample. This was expressed as a percentage of the total height of the liquid and the values given after 31 days storage are noted in the table below. As can be seen, samples with little rheological structure and a low Casson yield values gave high rates of sedimentation.

| | % settling after 31 days | Casson Yield |
|---|---|---|
| Formulation | storage at 40° C. | Value (τ₀) Pa |
| 1 | none | 2.888 |
| 2 | 1.00% | 10.160 |
| 3 | 4.95% | 25.72 |
| 4 | 4.20% | 3.332 |
| 5 | 2.22% | 16.170 |
| 6 | 8.51% | 9.476 |
| Comparative example 1 | n.a. | Not measurable |
| Comparative example 2 | 41.74% | 3.094E−6 |
| Comparative example 3 | 6.06% | 2.868 |
| Comparative example 4 | 76.29% | 1.852E−5 |
| Comparative example 5 | n.a. | not measurable |
| Comparative example 6 | 38.7% | 2.679E−6 |

1. A dispersion comprising
a) a biocide selected from tralopyril, zinc pyrithione, or tolylfluanid, or combinations thereof in an amount up to 80% by weight;
b) a polymeric surfactant selected from alkyd polyethylene glycols and ABA polyhydroxyester-PEG-polyhydroxyester copolymers, in an amount ranging from 0.1 to 30% by weight;
c) an anti-settling agent selected from fumed silica, calcium carbonate, modified castor oils, modified cellulose polymers, bentonite, hectorite, or chemically modified derivatives thereof, or mixtures thereof, and optionally propylene carbonate, in an amount ranging from 0.01 to 10% by weight;
d) a carrier liquid selected from isoparaffinic solvents, dearomatized aliphatic hydrocarbon fluids, heavy aromatic hydrocarbons, paraffin oils, toluene, ethylbenzene, trimethylbenzene, xylene, diisononyl phthalate and propylene oxide polyether polyols, or mixtures thereof; and;
e) optionally other formulation agents.

2. The dispersion as claimed in claim 1 wherein the biocide is tralopyril.

3. The dispersion as claimed in claim 1 wherein the biocide is zinc pyrithione.

4. The dispersion as claimed in claim 1 wherein the biocide is tolylfluanid.

5. The dispersion as claimed in claim 1 wherein the biocide is present in an amount ranging from 20 to 80% by weight.

6. The dispersion as claimed in claim 1 wherein the biocide is present in an amount ranging from 30 to 60% by weight.

7. The dispersion as claimed in claim 1 wherein the amount of polymeric surfactant ranges from 0.5 to 10% by weight.

8. The dispersion as claimed in claim 1 wherein the amount of anti-settling agent ranges from 0.1 to 5% by weight.

9. The dispersion as claimed in claim 1 wherein the polymeric surfactant is an alkyd polyethylene glycols.

10. The dispersion as claimed in claim 1 wherein the polymeric surfactant is an ABA polyhydroxyester-PEG-polyhydroxyester copolymers.

11. The dispersion as claimed in claim 1 wherein anti-settling agent is selected from quaternium 18-hectorite, a mixture of quaternium 18-hectorite and propylene carbonate, and a mixture of quaternium 90-bentonite with propylene carbonate

12. The dispersion according to claim 1 wherein the carrier liquid is selected from are isoparaffinic solvents, dearomatized hydrocarbon fluids, heavy aromatic hydrocarbons, paraffin oils, xylene, diisononyl phthalate, and propylene oxide polyether polyols.

13. The dispersion as claimed in claim 1 wherein the carrier liquid is selected from dearomatized aliphatic hydrocarbon fluids.

14. The dispersion according to claim 1 wherein the other formulation agents are selected from one or more inert fillers, resins or binders.
